(19) United States
(12) Patent Application Publication
(10) Pub. No.: US 2002/0174684 A1
(43) Pub. Date: Nov. 28, 2002

(54) Fused silica furnace and method

(76) Inventors: Paul S. Danielson, Corning, NY (US); John E. Maxon, Canton, NY (US); Robert S. Pavlik JR., Corning, NY (US); Daniel R. Sempolinski, Painted Post, NY (US)

Correspondence Address: Milton M. Peterson, Corning Incorporated, SP-TI-03, Corning, NY, 14831, US

(21) Appl. No.: 09/863,725

(22) Filed: May 23, 2001

(51) Int. Cl. C03B 20/00

(52) U.S. Cl. 65/17.4; 65/374.13

(57) ABSTRACT

A furnace for the deposition and collection of molten silica particles to form a solid body, the furnace comprising a collection vessel, the base of which is lined with a purified refractory material, and a method of forming the solid body which comprises lining the base of the collection cup with crushed particles of purified refractory material.

### FIELD OF THE INVENTION

A method and furnace for collecting fused silica particles with a high degree of purity.

### BACKGROUND OF THE INVENTION

The production of relatively pure metal oxides, by thermal decomposition of precursor materials, and deposition of the resulting metal oxides, is a well-known practice. One such process, that is of increasing commercial significance, is the production of fused silica by flame hydrolysis or pyrolysis of a silica precursor to produce molten silica particles.

The molten silica particles may be collected in a furnace component in the nature of a large, open vessel referred to as a cup. The large, fused silica body thus formed is commonly known as a boule. Subsequently, a group of boules may be integrated into a large telescope mirror for use in astronomy studies. Another use, now achieving considerable significance, is stepper lenses used in microlithography equipment. For this use, the boule is sliced into small pieces which are then finished for lens use.

The transmission requirements for stepper lenses continue to become increasingly stringent. In turn, this necessitates critical control of contaminants in the glass, particularly oxides of sodium, potassium and iron (Na, K and Fe). Currently, each of these must be reduced to a few parts per million (ppm) within the furnace refractory materials in order to produce an acceptable glass lens having impurity levels in parts per billion.

It has been found that a primary source of such oxide contaminants is the brick employed in constructing the collecting furnace. Particular care must be taken in the crown portion where molten glass may collect and drip onto the boule being formed. The very high temperatures involved in forming and collecting the molten silica particles, upwards of 1600° C., severely limit the refractory materials from which furnace brick may be formed. Accordingly, it has become customary to employ zirconium silicate, i.e., zircon, as a brick material.

Originally, when SiCl₄ was used as the silica precursor, contamination was not a serious problem. It is now believed that the chloride by-product tended to remove contaminating oxides from the brick. With the switch to precursors that did not contain chlorine, for example, siloxanes, the problem of contamination became serious. Since finding that the contaminant source was primarily the brick, a great deal of attention has been given to decreasing the content of contaminants in the brick.

Initially, attention was given to use of clean batch materials. More recently, attention has been given to treatment of the brick, either before or after furnace construction, to cleanse the brick of contaminants. Implementation of these measures has provided a greatly improved fused silica product. However, the increasingly stringent transmission requirements have required a further study of possible sources of contamination.

The vessel into which the molten silica particles are deposited is a cup-shaped refractory body. It has an essentially flat base that is the size of a cross-section of the boule to be formed. The base merges into an annular, vertical sidewall to form the vessel. The base tends to operate at a somewhat higher temperature than the wall during formation of a fused silica boule. Accordingly, it has been common practice to cover the base with a layer of material that will permit separation of the boule from the base refractory after the boule is formed. This has become known as “bait material” since it is subsequently removed. While various materials have been tried, quartz sand has proven most effective.

Heretofore, the quartz sand has not been considered a source of any problems. However, the ever increasing demand for improved transmission, and hence stricter control of contaminants, caused attention to be focused on this “bait” material. That, in turn, led to the present invention.

It is then a primary purpose to produce an improved fused silica material having a lesser degree of contaminant, and a consequent higher transmission, particularly for ultraviolet radiation.

Another purpose is to further control, and to eliminate, insofar as is feasible, sources of contaminating metal oxides from the furnace for, and the process of, collecting pure molten silica particles to form a boule of fused silica.

A further purpose is to provide a furnace having an improved vessel for a the collection of molten silica particles to form a boule.

A specific purpose is to provide a superior lining for the base of a vessel for collecting molten silica particles in a furnace.

### SUMMARY OF THE INVENTION

The invention resides in part in a furnace comprising an open vessel to collect molten silica particles to form a solid, fused silica body, the vessel being composed of a refractory material capable of withstanding a temperature of at least 1600° C., at least the base of the refractory vessel being lined with a material upon which the molten silica particles are deposited, the lining material being crushed particles of a purified, refractory material.

The invention further resides in a method of producing a solid body of fused silica which comprises forming molten, fused silica particles from a precursor material, providing an open, refractory vessel in a furnace, lining at least the base of the vessel with crushed particles of purified refractory material, and depositing the molten particles of fused silica on the lining material to form a solid, fused silica body.

### BRIEF DESCRIPTION OF THE DRAWINGS

In the accompanying drawings,

The single figure is a schematic representation of an apparatus and process for forming and depositing molten glass particles to produce a large body of fused silica.

### DESCRIPTION OF THE INVENTION

The conventional process employed in producing a fused silica boule is a one-step process. In this process, a carrier gas is bubbled through a feedstock that is maintained at a low temperature and that is a source of silicon. Vapors of the feedstock are entrained by the carrier gas and thereby transported to a reaction site. The reaction site is usually at the face of a number of burners mounted in the crown of a furnace. The furnace is adapted to the collection of fused silica particles and operates at a temperature above 1600° C. The feedstock and carrier gas pass through the burner system where the feedstock is combusted and oxidized to form molten particles of fused silica. These are then collected in a component of the furnace referred to as a cup.

Traditionally, the feedstock has been SiCl₄. The by-products of this material are highly corrosive and environmentally unfriendly. More recently, then, siloxanes have been substituted as “feedstock material.” This has led to an unforeseen problem of metal contamination of the fused silica, and consequent decreased radiation transmission in the products, particularly ultraviolet radiation. The present invention, then, is concerned with discovery of one source of such contamination, and minimizing contamination from that source.

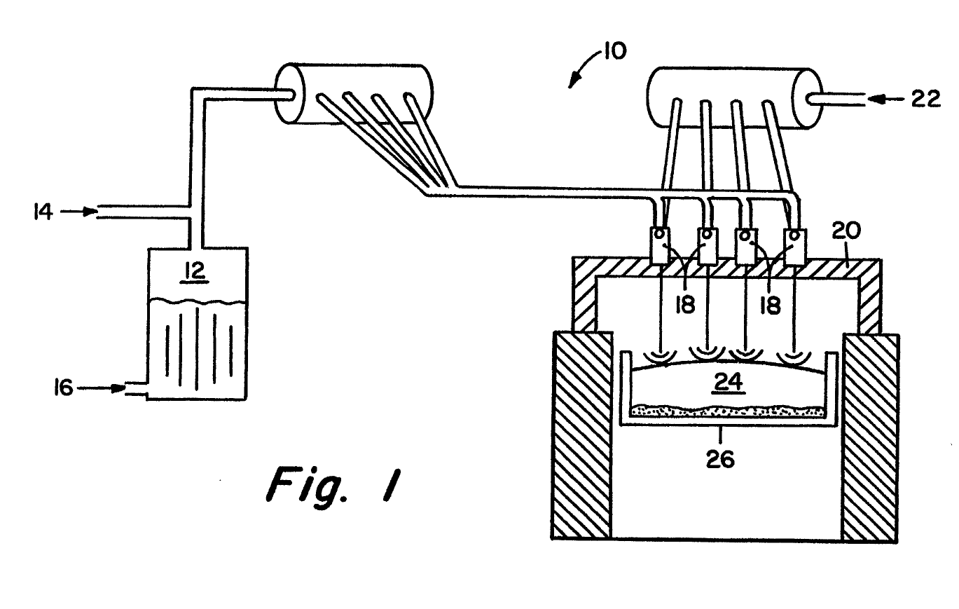

FIG. 1 in the accompanying drawing is a schematic representation of an apparatus and process for producing and depositing molten silica particles to build up a large, fused silica boule. The apparatus, generally designated by the numeral 10, includes a feedstock source 12. Nitrogen, or a nitrogen/oxygen mixture, is used as the carrier gas. A bypass stream of nitrogen 14 is introduced to prevent saturation of the vaporous stream. The vaporous reactant is passed through a distribution mechanism to the reaction site wherein a number of burners 18 are present in close proximity to a furnace crown 20. The reactant is combined with a fuel/oxygen mixture 22 at these burners, and is combusted and oxidized to deposit silica at a temperature greater than 1600° C. High purity, metal oxide soot and heat are directed downwardly from the refractory furnace crown 20. The silica particles are collected in a vessel 26 and there consolidated to a non-porous body 24, known as a boule.

The high temperatures involved seriously limit the refractory materials available for construction of crown 20 and collection vessel 26. For various reasons, zircon has become the material of choice. While zircon can be obtained in relatively pure form, considerable effort has been expended in further purifying both the zircon raw material and the materials used in processing it. The present invention involves a source of contamination not recognized heretofore.

Once formation of boule 24 in vessel 26 is complete, the furnace is allowed to cool, and the boule of fused silica removed for further processing. Initially, the furnace is dismantled leaving the boule resting on base 28 of vessel 26. The boule is then picked up by a forklift and moved for further processing. To facilitate this operation, it has been customary to provide a layer of quartz sand over the base 28 of vessel 26. The molten fused silica particles are deposited on this layer, rather than directly on base 28. The quartz sand layer serves as an initial barrier between the fused silica and the zircon refractory. It sinters, but remains friable enough to permit entry of the forklift blades.

Continuing efforts to improve transmission in lenses led to a suggestion that the quartz sand might be a source of contamination. Analyses of sand samples showed that the contents of Na, K and Fe, the primary contaminants, were on the order of 80 ppm Na, 80 ppm K and 140 ppm Fe. These values, not large by normal standards, are large when compared to the degree of purity required in the zircon furnace brick.

To test this suggestion, it was proposed to replace the quartz sand with a layer 30 of purified zircon material as used in brick production. As a source of such purified zircon, it was suggested that the zircon brick, customarily discarded after a furnace was torn down, be used. The brick would be crushed to provide a material of proper particle size.

This provided a means of using the spent zircon brick, which otherwise were simply discarded as waste. However, the brick, particularly those in the furnace crown, were known to contain a considerable amount of silica glass that condenses on and within the brick face. This, of course, would tend to fuse and flow on the surface of base 26, particularly under the mounting pressure.

We have found this problem can be largely avoided by sieving the crushed brick and using a certain fraction. It has been found that when a brick is crushed, the glass present tends to occur either as flakes or shards, or as a virtual fine dust. The size and shape of the former enable them to remain on, and to be removed by, a 4 mesh screen. The fines can then be removed with an 80 mesh screen through which they pass.

The fraction of material retained, that is the fraction between −4 and +80 mesh, is 60-70%. The bulk density of this material is about 1.2-1.4 g/cc, very close to that of the quartz sand it replaces.

It may be preferable to select the zircon material with a relatively coarse size since the purity level is essentially the same. Use of a relatively coarse material can be important where operating conditions are such that there is a tendency to “blow sand” during furnace preheat. Blowing of the bait material can create an uneven contour (trenches) in the bait. This in turn can adversely affect index homogeneity in the silica boule later. The coarser materials can resist the tendency to blow.

More important, however, analysis shows the principal sources of contamination to be only slightly greater than the purified brick, namely <2 ppm Na, 3 ppm K, and 6 ppm Fe. This represents an improvement of 20-40 fold over the quartz sand. Thus, use of the recycled brick has the dual virtues of taking advantage of the initial brick purification and avoiding a disposal problem.

To a large extent, the barrier layer 30 of purified zircon particles has proven adequate. However, to obtain the highest degree of purity in a boule, a further option is available. This consists in placing a thin sheet of fused silica 32 over the zircon barrier layer 30 before depositing molten fused silica. In a test run, for example, a 2.5 to 3.7 cm. thick sheet of fused silica was cut from a boule and placed over the zircon barrier layer 30.

There are at least three potential advantages to be obtained from this option. First, during the initial furnace heat-up, the fused silica glass will soften and conform to the surface of the zircon layer. This provides a relatively smooth surface on which to deposit the molten fused silica particles. Second, the zircon barrier layer is effectively isolated from contact with the remainder of the furnace during heat-up and subsequent boule formation. Finally, the sheet acts as a barrier to diffusion of contaminants from the zircon into the boule, thus providing a greater portion of the boule adequately pure for use.

We claim:

1. A furnace comprising an open vessel to collect molten silica particles to form a solid, fused silica body, the vessel being composed of a refractory material capable of withstanding a temperature of at least 1600° C., at least the base of the refractory vessel being lined with a material upon which the molten silica particles are deposited, the lining material being crushed particles of a purified, refractory material.

2. A furnace in accordance with claim 1 in which the lining material is essentially the same refractory material as the vessel.

3. A furnace in accordance with claim 1 in which the vessel is composed of zircon.

4. A furnace in accordance with claim 1 in which the lining material is composed of crushed particles of recycled purified material.

5. A furnace in accordance with claim 1 wherein the lining material contains, as contaminants less than 2 ppm Na and no more than 3 ppm K and 6 ppm Fe.

6. A furnace in accordance with claim 1 which further includes a thin sheet of purified glass overlying the lining material on the base of the vessel.

7. A furnace in accordance with claim 6 wherein the layer of glass is fused silica.

8. A method of producing a solid body of fused silica which comprises forming molten, fused silica particles from a precursor material, providing an open, refractory vessel in a furnace, lining at least the base of the vessel with crushed particles of purified refractory material, and depositing the molten particles of fused silica on the lining material to form a solid, fused silica body.

9. A method in accordance with claim 8 which comprises lining at least the base of the vessel with crushed particles of zircon.

10. A method in accordance with claim 9 which comprises crushing and screening used zircon brick to obtain crushed particles.

11. A method in accordance with claim 10 which comprises screened crushed zircon brick to provide a −4 to +80 mesh size fraction.

12. A method in accordance with claim 8 which further comprises placing a thin sheet of purified glass over the lining material on the base of the vessel and then depositing the molten silica particles on such glass sheet.

13. A method in accordance with claim 12 which comprises placing a thin sheet of fused silica over the lining material.
